(19) United States
(12) Patent Application Publication
(10) Pub. No.: US 2022/0180374 A1
(43) Pub. Date: Jun. 9, 2022

(54) ARCHITECTURE, SYSTEMS, AND METHODS USED IN CARBON CREDIT AND BLOCK CHAIN SYSTEMS

(71) Applicant: Jason Cooner, Pinson, AL (US)

(72) Inventor: Jason Cooner, Pinson, AL (US)

(21) Appl. No.: 17/598,855

(22) PCT Filed: Feb. 25, 2019
(86) PCT No.: PCT/US19/19442

§ 371 Date: Sep. 27, 2021

Related U.S. Application Data
(60) Provisional application No. 62/610,479, filed on Dec. 26, 2017.

(51) Int. Cl. G06Q 30/00; G06Q 10/00; G06Q 40/04

(52) U.S. Cl. CPC G06Q 30/018; G06Q 40/04; G06Q 10/30

(57) ABSTRACT

Embodiments of architecture, systems, and methods employ sensor data and blockchain to verify and promote the reduction of undesirable waste products, reduction of energy usage, more efficient energy generation, and reduction in consumption of limited resources where the sensor data may be generated from a sensor of an Internet of Things system. Other embodiments may be described and claimed.

### TECHNICAL FIELD

Various embodiments described herein relate generally to architecture, systems, and methods used in carbon credit and block chain systems.

### BACKGROUND INFORMATION

It may be desired to store Internet of things or other sensor data. The present invention provides an architecture, systems, and methods that securely and immutable store Internet of things or other sensor data and may also verify such data.

### BRIEF DESCRIPTION OF THE DRAWINGS

FIG. 1 is a block diagram of a sensor data secure storage and verification (SDSSV) architecture according to various embodiments.

FIG. 2 is a diagram of communications between a sensor system, a cloud server system, verification system, and 3^{rd} party system according to various embodiments.

FIG. 3A is a block diagram of sensor architecture according to various embodiments.

FIG. 3B is a block diagram of another sensor architecture according to various embodiments.

FIG. 4 is a flow diagram illustrating several methods according to various embodiments.

FIG. 5 is a block diagram of an article according to various embodiments.

### DETAILED DESCRIPTION

In an embodiment, sensor data may be collected from a product or device including an Internet of Things sensor. The sensor data may represent energy related information including energy generation or consumption. The sensor data may also represent consumption of limited resources including energy, water, natural products, man made products, and other limited resources. The sensor data may also represent the generation or reduction of consumption of undesirable gases, liquids, or other materials (waste materials) including greenhouse gases (GHG). Organizations, governments at various levels, and other bodies may regulate the generation and consumption of energy and consumption of limited resources and the generation of undesirable elements including waste.

Such bodies may create incentives, penalties, costs, credits, and debits across markets and locations to promote the reduction of undesirable waste products, reduction of energy usage, more efficient energy generation, and reduction in consumption of limited resources. Sensors may be employed in equipment that generates the undesirable waste products, uses energy, generates energy, and consume limited resources. In an embodiment, the sensor data may be securely recorded, stored, and may also be verified by a certified verification system. In an embodiment, the verified sensor data may be used to provide the incentives, penalties, costs, credits, and debits across markets and locations and to promote the reduction of undesirable waste products, reduction of energy usage, more efficient energy generation, and reduction in consumption of limited resources.

In an embodiment, other parties may be able to purchase credits generated based on verified sensor data to offset consumption or penalties for their activities or further sale on other markets based on agreements by various regulating bodies locally, regionally, or worldwide.

The Internet of Things is a new style of architecture that may connect every product electronically, and most likely wirelessly, to the Internet. Many device manufacturers are currently building in sensors with radio communication that would allow the product's internal status, usage patterns, or other information regarding operation or process to be sent out via radio signal to hardware devices that can listen to their communication and transmit that communication to the Internet, or have a computer hardware or software system on the Internet that could send information to the product and have it respond in kind. This two-way communication between the product and the Internet is now being referred to as the “Internet of Things” computing architecture.

The means by which the products may primarily communicate to the Internet may be through hardware devices known as gateways and/or routers that can send and/or receive the signals from the product. These communications may or may not occur over a cable and/or “short range” and/or “mid-range” communications such as WIFI, RFID, ZigBee, Bluetooth, Openware (our own four-phase commit protocol described in detail in previously mentioned filings), LoRaWAN (LoRa), SigFox, cellular, satellite, or any other ad-hoc wireless communications protocol in any combination, and then send them to the Internet via a dedicated or intermittent Internet connection (which may be in turn wireline or wireless, or any other combination mentioned above).

The routers or gateway devices that are currently available are devices such as Raspberry PI, Android devices, etc. Although these devices may work in limited capacity, they are in no way equipped to handle multiple short-range transmission protocols “out of the box” and are not capable of connecting all products in a local environment to a single gateway or router device. One new router/gateway device design could be a hardware design that can scan a household, manufacturing facility, or other local region for wireless transmissions such as radio signals. Then decode the signal into raw data that the gateway/router device can understand.

These wireless transmissions can be WIFI, RFID, ZigBee, Bluetooth, Openware, LoRaWAN (LoRa), SigFox, cellular, satellite, or any other form of “short range”, “mid-range”, or “long range” radio signal protocol or airborne signal otherwise that may be used for IoT systems. Once the signal is decoded, the router can then scan for such signals on a scheduled interval or permanently as to act as a receiver for the signal detected. This may in turn allow the gateway/router to undergo an initial setup routine to decode all signals coming from any radio frequency enabled devices or products and then normalize them into a language the gateway/router can understand.

The gateway/router can then transmit the normalized information from one or more devices or products to the Internet such as a cloud environment like Microsoft's Azure platform, Amazon's AWS (Web Services) platform, or some other computer network residing on the Internet or computer communications network. The data can then possibly be stored and/or used to drive business processes such as rules engines or business workflows in real time or at some point in the future. Such processes could include emailing parties when certain information indicates they be notified. As an example, if a refrigerator warms to a certain level that would indicate the cooling system is failing, then a service technician can be notified via text message, email, or other form of communication. The service technician can then be instructed to come out for a service check and possibly fix the refrigerator before all the food spoils. The gateway/router can also support devices being connected by cable directly as opposed to wirelessly for communications.

The scanning mechanism described above can be designed in the following ways. The gateway/router can first scan for a specified period to see which products are transmitting information and record which frequencies, baud rates, and/or additional product information can be picked up through real time detection and/or decryption and/or decoding of individual packets of wireless transmission data. All aspects of the different types of communication received from the product(s) in the local environment by the gateway/router should be recorded. The protocol format(s) that are detected can then be looked up via a database on the gateway/router and the product type(s) and wireless transmission type(s) can be recorded as a local wireless profile for the gateway/router to immediately and/or in the future.

The information collected by the scan may also be sent to the Internet for decryption or decoding of the transmission type via a product wireless protocol catalog kept in a database on the Internet. The product type(s) and wireless transmission type(s) can then be sent back to the gateway/router as a profile so the gateway/router knows how to communicate with each product in the local environment. This information can be stored and/or used for immediate and/or future use. Once the local “short range” or “mid-range” network protocol(s) are deciphered and/or decoded and the gateway/router knows how to send and receive data transmissions to and from the product(s), then the gateway/router can then poll the different frequencies and baud rates to receive any transmissions from the products on a scheduled or one-time interval. The gateway/router may implement one or more antennas to perform the sending and receiving of transmissions to different products, if more than one product is sending and/or receiving transmissions.

If a single antenna is used to communicate with multiple products, then the gateway/device may have to reprogram the antenna and/or computer logic on the gateway/device driving the antenna reception on a programmed time interval or for a single invocation to be able to send and receive on different wireless protocols on scheduled intervals. In other words, the antenna may have to be tunable to receive different frequencies and/or baud rates from potentially different pick parts and possibly additional information if needed to perform having a single antenna send and receive communications from multiple products.

One example of this type of single antenna/multiple wireless protocol in use implementation is if there are five products that can transmit sensor information to the gateway/router. The gateway/router may need to cycle through the different protocols/product types profile created in the setup to scan for all product communications in a given interval at a rate that collectively doesn't exceed the maximum amount of time the products may try to resend information. In other words, if all five products may attempt to transmit for 1 minute before cancelling their transmission to the gateway/router, then the gateway/router may scan on each frequency and baud rate for no more than 12 seconds at a time in a single cycle so that the gateway/router can detect any transmission from any product before the product decides to cancel the transmission.

Since there are 5 products in the local environment, 12 seconds of scan for communications from each product may result in 1-minute cycles for scanning all products. This may ensure that one gateway/router device always receives communication initiated by a product. If the gateway/router is designed with multiple antennas, each antenna could be utilized in a way to talk to multiple products or a single individual product per antenna. If each product has a dedicated antenna, then the cycling of scanning for an individual product can be eliminated as each antenna can be constantly listening for communications from each individual product.

Additional information such as pick part type used by the manufacturer and any encryption-scheme specific information or other information may be needed to determine how to decrypt and/or decode the data from the products or transmit information to the products, both of which should be enabled by such a system. Specific product wireless profiles could be built into the gateway/router by the manufacturer and/or configured in advance of deployment, or pushed to the gateway/router so that the scanning mechanism is not needed and the gateway/router is shipped to the customer already configured to communicate with certain products and/or product types, or the wireless profile configuration can be controlled by an interface on the Internet via a cloud-based web interface or any other computer interface such as a mobile device, tablet, etc.

The gateway/router design should implement several security features that may ensure no firmware or data transmissions are ever tampered with or intercepted in clear text. This may require the data transmissions be encrypted from the sensor pack all the way through the gateway/router to the Internet as well as to the client interface. The firmware should be signed through a code certificate mechanism and written to read only data storage on all sensor packs as well as gateway/router devices to ensure no tampering with the hardware. A unique id should be assigned to each piece of hardware used in the system in advance of deployment so that each piece of equipment can be uniquely identified in the system.

Data that is no longer needed should be erased from local memory so that no device can retain information sent to or received by the sensors. There should also be a transaction layer that begins at the sensor pack and/or Internet, whoever the originator of the transmission is, that may maintain integrity of communication all the way through the use of the system. This could be implemented as a two-phase commit, as current Internet Protocol is designed, or it can be implemented as a four-phase commit as described in previously filed patents referenced in the introduction of this patent filing. The gateway/router devices can be implemented in a chain of “grid enabled” devices so that the sensor pack may communicate with the Internet through several gateway/router devices en route during transmission.

Transactions could be used to push logic flow from the Internet to the sensor pack so that the sensor pack is capable of performing some of the logic that would normally be executed on the servers. This could lead to a more distributed computing model for systems based on the “Internet of Things” architecture as described herein. Sensor packs could be used to manipulate robots or perform other actions within products for a number of reasons. One could be for product maintenance. Another could be for product execution, such as running a dishwasher at a scheduled time, or turning on and off lights in a warehouse.

An additional gateway/router design could implement a “long range” wireless transmission protocol such as cellular, satellite, or other communications protocol that would not be considered “short range” or “mid-range”, in addition to previously mentioned designs in this and previous filings referenced above. This would be done to wirelessly backhaul data transmissions to the Internet or have the Internet enabled system send transmissions to the gateway/router via a wireless “long range” transmission protocol.

The above described gateway/router designs could be used in conjunction with any of the sensor and sensor pack designs mentioned herein as well as in patents referenced in the introduction to this patent filing.

The “Edge” is the “Internet of Things”′ (IoT for short) front-line of where technology intersects with business and people, capturing raw data used by the rest of the IoT system. Data is captured by embedding sensors in consumer devices (i.e. fitness trackers, thermostats) appliances or industrial systems (i.e. heating & cooling systems, factory automation) or more specialized applications such as remotely monitoring food temperature and humidity. Such devices can be referred to in this discussion as “Sensor Devices”.

Data can then be passed to a “Router” and/or “Gateway” or other “Aggregation Points” that can provide some basic data analytics (parsing raw data) before being sent to the IoT Platform via an Internet connection and beyond. “Routers” can be thought of as local grid or mesh networks whereby implementations such as Bluetooth, ZigBee, WIFI, ANT, OpenWare, LoRa, SigFox, or other short to mid-range wireless transmissions are used to communicate between Sensor Devices and Gateways. Gateways can be thought of as Internet-enabled hardware devices (usually through a wireless WIFI, cellular based such as GSM, CDMA, or other mobile phone carrier network, or landline connection) that communicate either directly to sensors, to sensors through Routers, or a hybrid of both Routers and sensors directly to allow for data to be passed bi-directionally to an Internet platform such as a cloud computing environment or computer network. Also, IoT is not just about capturing data but can also alter the operation of a device with an actuator or other configurable components.

The functionality, shape and size of “Edge” devices are mostly limited by human imagination since most of the technology already exists. For systems including a large number of devices or sensors, gateways and aggregation points serve as the primary connection point with the IoT platform and can collect and prepare data in advance sending the data to the IoT Platform.

Definitions of Edge Components

Environment: This is the operating environment of the sensor or device including natural environments (i.e. outside) or man-made (i.e. buildings, machinery or electronic devices). The environment is important when selecting the sensor to ensure it can withstand the ongoing demands of the environment in addition to power management and maintenance considerations of the “Edge” components.

Sensors: This is where the collection of IoT data begins. In most cases the raw data is analog and is converted to a digital format and sent through a serial bus (i.e. I2C) to a microcontroller or microprocessor for native processing. Typical sampling rates for sensors are 1,000 times per second (1 kilohertz) but can vary widely based on need. As noted, sensors may be employed in equipment that generates the undesirable waste products, uses energy, generates energy, and consume limited resources and the data may be routed via the IoT architecture for storage and verification or processing.

Devices or “Things”: Sensors are typically embedded within existing devices, machines or appliances (i.e. wind turbines, vending machines, etc.) or in more complex systems such as oil pipelines, factory floors, etc. . . . . To eliminate sensors just sending a copious amount of raw data, some of these devices have basic analytical capabilities built-in which allow for some basic business rules to be applied (i.e. send an alert if the temperature exceeds 120 degrees Fahrenheit), as opposed to just sending a live data stream.

Routers: A router broadcasts a radio signal that is comprised of a combination of letters and numbers transmitted on a regular internal of approximately 1/10th of a second. They can transmit at this rate, but in an “intelligent” hardware scenario (Intelligent Sensors and/or Routers) the transmission may likely be much slower, as in 5-10 second intervals or exception based as needed. The term “Intelligent” simply means that there is application logic via software and/or firmware that may provide some logic or filtering of sensor data so that transmissions are only sent when conditions are met or a change in sensor data warrants an update to the network.

Routers provide an added dimension “Edge” computing with the ability to combine the location of either Bluetooth, WiFi, ZigBee, ANT, OpenWare, LoRa, SigFox, or other short or mid-range wireless communication protocol equipped mobile devices (i.e. customers) and/or wired devices along with other factors such as current environmental and weather conditions. For example, by tracking the location of devices, more context relevant information can be pushed to the device such as special offers and recommendations based current conditions.

Aggregation Point or Gateway: The Gateway or Aggregation Point is the final stop before data leaves the “Edge”. While deploying a gateway is optional, it is essential when creating a scalable IoT system and to limit the amount of unneeded data sent to the IoT platform. Key functions include:

Convert the various data models and transport protocols used in the field, such as Constrained Application Protocol (CoAP), Advanced Message Queuing Protocol (AMQP), HTTP and MQTT, to the protocol(s), data model and API supported by the targeted IoT platform. The HTTP/HTTPS and MQTT are what the gateways may talk to the IoT Platform with. Other local protocols like serial, ZigBee, Bluetooth, WIFI, LoRa, SigFox, cellular, satellite, and/or Openware may normally be used from Router to Gateway.

Data consolidation and analytics (“Edge analytics”) to reduce the amount of data transmitted to the IoT platform so network bandwidth is not overwhelmed with meaningless data. This is especially critical when IoT systems include thousands of sensors in the field.

Real-time decisions that would take too much time if the data was first sent to the IoT Platform for analysis (i.e. emergency shut-down of a device). Send data from legacy operational technology that may not have the ability to send data to an IoT platform.

Design Considerations

When thinking about the technology and design for the “Edge” of an IoT solution, business requirements are more important here than the technology itself, so IT personnel may have to work closely with the business to identify and meet the functionality, costs and security requirements. Once these business requirements are clearly understood does the technology selection process begin (i.e. sensors, gateways and design). At the same time, IT brings insights into the potential and capabilities provided by IoT technology which can help drive use case scenarios so collaboration between the business and IT is essential.

After defining the business requirements and the focus has shifted to the technical design of an IoT solution, it is important to first explore any unused IoT infrastructure already built into existing machinery, hardware and software (“Brownfield Opportunity”). There are many types of devices and machines out there already equipped with sensor type technology that is simply waiting to be tapped into. This is the low-hanging fruit that can be quickly leveraged with minimal disruption to the business because the technology has already been adopted while helping accelerate IoT initiatives. The “Greenfield Opportunity” is for IoT opportunities in enterprise environments where no existing IoT infrastructure exists.

There are two major deployment options for “Edge” devices used in an IoT solution:

“Edge” deployment without aggregation.

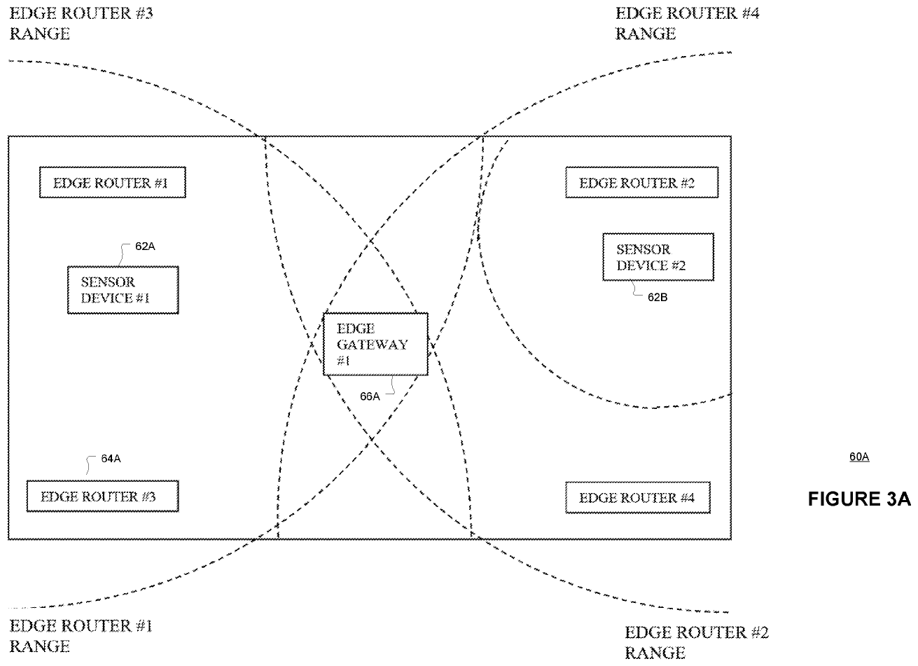

“Edge” deployment with a gateway or aggregation point as shown in FIGS. 3A and 3B.

No Aggregation: Every device is connected to a network (usually the Internet or other IP based system) enabling the device to send and receive data directly to the IoT Platform. This means each device must have a dedicated network and the ability send and receive data using APIs, the data model and transport protocol required by that IoT platform. The device must also have enough computing power for some analytics and to make real-time decisions such as turning off machine if the temperature passes a specified threshold. Finally, the device must have some sort of user interface for maintenance and ongoing updates.

Non-aggregated designs work best when there are few other devices in the area competing for connectivity. Usually, these devices also have more processing power, memory and an operating system capability so it is easier to add or adjust functionality. However, this added device capability is typically more expensive to implement and non-aggregated designs typically don't scale well with each device requiring individual attention to maintain and secure (unless the IoT Platform provides scalable “Edge” device management). Another potential challenge to consider is if the device does not support the IoT platform's transport protocol. In such cases, additional code may need to be added to each device so support the required APIs, data model and transportation protocol.

Aggregation: This design model includes a gateway or some other type of aggregation point connecting “Edge” devices and the IoT platform.

Aggregation designs are ideal for IoT implementations with a large number of sensors, a fleet of devices and where the devices are fixed and localized deployments. This is especially true for scaling and consolidating device management where multiple endpoints can be managed from a single location. Using gateways and other aggregation points in an IoT design allows for cheaper sensors and devices with less computing power while allowing for integration with legacy operational technology that otherwise may not have been available. Gateways can also consolidate the various protocols, data models and APIs from the various end points to the standards required by the IoT platform while also providing a location before data reaches the IoT platform for additional intelligence and intelligence to reduce the amount of data sent to the platform.

However, aggregated designs also provide another layer of complexity into the design by adding gateways or other aggregation points. This essentially means another link in the chain that needs to be monitored and addressed when there are issues. Additionally, without built-in redundancy into the design, this could also lead to a single point of failure when a gateway device goes down and all of the connected devices have no way of communicating with the IoT platform. As a result, all aggregation points must be designed with built-in redundancy.

Sensors

IoT sensors are basically a monitoring or measuring device embedded into machine, system or device with an API enabling it to connect and share data with other systems. However, sensors can create copious amounts of data which may have no practical value so analytics or exception-based models are applied to reduce it to more of a meaningful dataset before transmission. Data is typically transmitted via an IEEE 802.1 network using an Internet Protocol (IP) to a gateway, router, receiver or aggregation point. The transmission frequency can be real-time streaming, exception-based, time intervals or when polled by another system.

The IoT sensor market is divided into two broad categories. Original Device Manufacturers (ODMs) and Original Equipment Manufacturers (OEMs). ODMs design manufacture the core sensor technology (pressure, temperature, accelerometers, light, chemical, etc.) with over 100,000 types of sensors currently available for IoT solutions. These sensors typically do not include any of the communication or intelligence capabilities needed for IoT solutions so OEMs embed ODM sensors into their IoT devices while adding the communications, analytics and other potential capabilities needed for their specified markets. For example, an OEM who builds a Building Automation IoT application may include various sensor types such as light (IR or visual), temperature, chemical (CO2), Accelerometer and contact.

FIG. 3A is a block diagram of sensor architecture 60A according to various embodiments. FIG. 3B is a block diagram of another sensor architecture 60B according to various embodiments. As shown in FIGS. 3A and 3B, architecture 60A and 60B may include multiple sensors 62A, 62B that may be coupled to an Edge gateway 66A via one or more Edge routers 64A. An embodiment shown in FIG. 3B, may further include a WIFI gateway 68A in addition to the Edge gateway 66A. The gateways 66A, 68A may enable data to be communicated with the sensor devices 62A, 62B via another network.

The ODM marketplace is more consolidates and primarily includes established microelectronics and micro processing incumbents who already have the manufacturing facilities and market share such as ST Microelectronics, IBM, Robert Bosch, Honeywell, Ericsson, ARM Holdings and Digi International. On the flip side, the OEM marketplace more of the Wild West. It includes some of the industry heavyweights but is full of a new generation of startups seeking to capitalize on the IoT market. For example, we have Intel, Fujitsu, Hitachi and Panasonic, in addition to a slew of other companies such as Lanner, iWave, Artik, and Inventec. The scope of this paper does not include an in-depth analysis of the ODM and OEM vendor landscape.

The following diagram illustrates the typical layout of an IoT Wireless Sensor Device:

Current State-of-the-Union

Some of the major factors driving the growth of the IoT sensor market includes the development of cheaper, smarter and smaller sensors.

While the IoT sensor and device markets are exciting, dynamic and enjoying growth, the coming wave of these small, embedded, low-power, wireless and wearable devices still do not is enjoy ubiquitous and universal access to the Internet. Due to current battery constraints and longevity, these devices tend to rely on low-power communication protocols such as Bluetooth Low Energy (BLE) as opposed to the more connected and more power intensive protocols such as WiFi and cellular (GSM, 3G/4G, etc.). As a result, most of these devices require an application layer gateway capable of translating the communication protocols, APIs and data models to transmit to the Internet and IoT platform.

Future Trends

While the majority of IoT applications have traditionally been focused on driving operational efficiencies and cost savings, over the next 12 months, Gartner forecasts enhanced customer experience and new customer-based revenue applications may take the lead in over the next 12 months.

The future growth of IoT sensors may be driven by the growing demand for smart devices and wearables, the need for real-time computing and applications, supportive government policies and initiatives, the deployment of IPv6 and the role of sensor fusion. Sensor Fusion is essential the current and future demands of IoT. Sensor Fusion combines data from multiple sensors in order to create a single data point for an application processor to formulate context, intent or location information in real-time for mobile, wearable and IoT devices. It is basically a setoff adaptive prediction and filtering algorithms to deliver more reliable results such as compensating for drift and other limitations of individual sensors.

By combining the growth projections of IoT (50 billion connected devices and a $7.1 trillion market) with the market focus on IoT sensor capability and performance, IoT sensors may be one of the most dynamic and explosive sectors in the market. There may continue to be new OEMs selling IoT applications but the market may also begin to consolidate as the market matures, communication standards are adopted and through M&A activity.

Baseline Requirements when Selecting a Sensor Device:

Security

Physical

Firmware

Data

Transmission

Power management

Battery life

Recharge Ability

Analytical capability

Sensors or devices producing large amounts of data or IoT systems using a large number of sensors may need to have analytical capability on the “Edge” to filter and select which data may be transmitted to the IoT Platform and beyond. Without “Edge” Analytics, the sheer volume of data can overload networks, create exorbitant communications costs and generate so much data that it becomes very difficult for it meaningful. Additional analytics may happen at the IoT Platform and enterprise applications using the data.

Exception based reporting . . .

Communication protocols

Wireless API

Device Maintenance Requirements . . .

Gateways/Routers/Sensor Devices

Information from the “Edge” sensors can be integrated through an Internet enabled platform like an “IoT Platform” such as Microsoft's Azure IoT Platform to perform various services for the customer. Such services could also be integrated into a company's Enterprise Resource Planning or Customer Resource Management software to perform additional services such as scheduling a service call for a failing home appliance or notifying technical support that a particular robotic arm on a manufacturing floor is not operating correctly.

The “Edge” tier of an IoT architecture should consider using an application tier protocol for communicating with servers in an IoT Platform via a standard such as IoTivity from the Open Connectivity Foundation, the AllJoyn Framework from the AllSeen Alliance, or any other IoT specific protocol for application architecture. Such protocols may allow for Sensor Devices to be registered with an IoT Platform and then have them communicate one way or bi-directionally with the IoT Platform during operation. The “Edge” tier can also be integrated into a Device Manager service on the IoT Platform tier so that Sensor Devices, Routers, and/or Gateway Devices can be observed and managed on the IoT architecture. This may provide availability support so that all devices utilized on the “Edge” tier of the IoT architecture can be monitored and serviced as needed.

Blockchain Data Storage for IoT Implementations

The overall trading system technical architecture should implement a “blockchain” based transaction recording mechanism to reduce fraud and improve system reliability in particular where the sensor data is related to critical data or subject to verification. According to Wiki: A blockchain—originally block chain—is a continuously growing list of records, called blocks, which are linked and secured using cryptography. Each block typically contains a hash pointer as a link to a previous block, a timestamp and transaction data. By design, blockchains are inherently resistant to modification of the data. A blockchain can serve as “an open, distributed ledger that can record transactions between two parties efficiently and in a verifiable and permanent way.” For use as a distributed ledger, a blockchain is typically managed by a peer-to-peer network collectively adhering to a protocol for validating new blocks. Once recorded, the data in any given block cannot be altered retroactively without the alteration of all subsequent blocks, which needs a collusion of the network majority.

Blockchains are secure by design and are an example of a distributed computing system with high Byzantine fault tolerance. Decentralized consensus has therefore been achieved with a blockchain. This makes blockchains potentially suitable for the recording of events, medical records, and other records management activities, such as identity management, transaction processing, documenting provenance, or food traceability.

Many aspects of the blockchain design are desirable for a commodity exchange and/or trading platform. However, a blockchain-based architecture isn't necessarily required to implement a carbon credit or expanded commodity exchange. Either form should support the notion of immediate buy/sell transactions, options, forwards and/or futures, and swaps.

The work on a cryptographically secured chain of blocks was described in 1991 by Stuart Haber and W. Scott Stornetta. In 1992, Bayer, Haber and Stornetta incorporated Merkle trees to the blockchain as an efficiency improvement to be able to collect several documents into one block.

A distributed blockchain was conceptualized by an anonymous person or group known as Satoshi Nakamoto in 2008 and implemented the following year as a core component of the digital currency bitcoin, where it serves as the public ledger for all transactions. Through the use of a peer-to-peer network and a distributed timestamping server, a blockchain database is managed autonomously. The use of the blockchain for bitcoin made it the first digital currency to solve the double spending problem without requiring a trusted administrator. The bitcoin design has been the inspiration for other applications.

The words block and chain were used separately in Satoshi Nakamoto's original paper in October 2008, and when the term moved into wider use it was originally block chain, before becoming a single word, blockchain, by 2016. In August 2014, the bitcoin blockchain file size reached 20 gigabytes. In January 2015, the size had grown to almost 30 gigabytes, and from January 2016 to January 2017, the bitcoin blockchain grew from 50 gigabytes to 100 gigabytes in size.

By 2014, “Blockchain 2.0” was a term referring to new applications of the distributed blockchain database. The Economist described one implementation of this second-generation programmable blockchain as coming with “a programming language that allows users to write more sophisticated smart contracts, thus creating invoices that pay themselves when a shipment arrives or share certificates which automatically send their owners dividends if profits reach a certain level.” Blockchain 2.0 technologies go beyond transactions and enable “exchange of value without powerful intermediaries acting as arbiters of money and information”. They are expected to enable excluded people to enter the global economy, enable the protection of privacy and people to “monetize their own information”, and provide the capability to ensure creators are compensated for their intellectual property. Second-generation blockchain technology makes it possible to store an individual's “persistent digital ID and persona” and are providing an avenue to help solve the problem of social inequality by “potentially changing the way wealth is distributed”. As of 2016, Blockchain 2.0 implementations continue to require an off-chain oracle to access any “external data or events based on time or market conditions that need to interact with the blockchain”.

In 2016, the central securities depository of the Russian Federation (NSD) announced a pilot project based on the Nxt Blockchain 2.0 platform that would explore the use of blockchain-based automated voting systems. Various regulatory bodies in the music industry have started testing models that use blockchain technology for royalty collection and management of copyrights around the world. IBM opened a blockchain innovation research centre in Singapore in July 2016. A working group for the World Economic Forum met in November 2016 to discuss the development of governance models related to blockchain. According to Accenture, an application of the diffusion of innovations theory suggests that in 2016 blockchains attained a 13.5% adoption rate within financial services, therefore reaching the early adopters' phase. In 2016, industry trade groups joined to create the Global Blockchain Forum, an initiative of the Chamber of Digital Commerce.

In early 2017, the Harvard Business Review suggested that blockchain is a foundational technology and thus “has the potential to create new foundations for our economic and social systems.” It further observed that while foundational innovations can have enormous impact, “It may take decades for blockchain to seep into our economic and social infrastructure.”

A blockchain facilitates secure online transactions. A blockchain may be a decentralized and distributed digital ledger that is used to record transactions across many computers so that the record cannot be altered retroactively without the alteration of all subsequent blocks and the collusion of the network. This allows the participants to verify and audit transactions inexpensively. They are authenticated by mass collaboration powered by collective self-interests. The result is a robust workflow where participants' uncertainty regarding data security is marginal. The use of a blockchain removes the characteristic of infinite reproducibility from a digital asset. It confirms that each unit of value was transferred only once, solving the long-standing problem of double spending. Blockchains have been described as a value-exchange protocol. This blockchain-based exchange of value can be completed more quickly, more safely and more cheaply than with traditional systems. A blockchain can assign title rights because it provides a record that compels offer and acceptance.

A blockchain database may consist of two kinds of records: transactions and blocks. Blocks hold batches of valid transactions that are hashed and encoded into a Merkle tree. Each block includes the hash of the prior block in the blockchain, linking the two. Variants of this format were used previously, for example in Git. The format is not by itself sufficient to qualify as a blockchain. The linked blocks form a chain. This iterative process confirms the integrity of the previous block, all the way back to the original genesis block. Some blockchains create a new block as frequently as every five seconds. As blockchains age they are said to grow in height.

Sometimes separate blocks can be produced concurrently, creating a temporary fork. In addition to a secure hash-based history, any blockchain has a specified algorithm for scoring different versions of the history so that one with a higher value can be selected over others. Blocks not selected for inclusion in the chain are called orphan blocks. Peers supporting the database have different versions of the history from time to time. They only keep the highest scoring version of the database known to them. Whenever a peer receives a higher scoring version (usually the old version with a single new block added) they extend or overwrite their own database and retransmit the improvement to their peers. There is never an absolute guarantee that any particular entry may remain in the best version of the history forever.

Because blockchains are typically built to add the score of new blocks onto old blocks and because there are incentives to work only on extending with new blocks rather than overwriting old blocks, the probability of an entry becoming superseded goes down exponentially as more blocks are built on top of it, eventually becoming very low. For example, in a blockchain using the proof-of-work system, the chain with the most cumulative proof-of-work is always considered the valid one by the network. There are a number of methods that can be used to demonstrate a sufficient level of computation. Within a blockchain the computation is carried out redundantly rather than in the traditional segregated and parallel manner.

By storing data across its network, the blockchain eliminates the risks that come with data being held centrally. The decentralized blockchain may use ad-hoc message passing and distributed networking. Its network lacks centralized points of vulnerability that computer crackers can exploit; likewise, it has no central point of failure. Blockchain security methods include the use of public-key cryptography. A public key (a long, random-looking string of numbers) is an address on the blockchain. Value tokens sent across the network are recorded as belonging to that address. A private key is like a password that gives its owner access to their digital assets or otherwise interact with the various capabilities that blockchains now support. Data stored on the blockchain is generally considered incorruptible.

Every node or miner in a decentralized system may have a copy of the blockchain. Data quality may be maintained by massive database replication and computational trust. No centralized “official” copy exists and no user is “trusted” more than any other. Transactions are broadcast to the network using software. Messages are delivered on a best effort basis. Mining nodes validate transactions, add them to the block they are building, and then broadcast the completed block to other nodes. Blockchains use various time-stamping schemes, such as proof-of-work, to serialize changes. Alternate consensus methods include proof-of-stake and proof-of-burn. Growth of a decentralized blockchain is accompanied by the risk of node centralization because computer resources required to operate bigger data become more expensive.

The blockchain mechanism could be used for registering users of the IoT implementation, as well as registering all the equipment necessary to implement the carbon credit/allowance/certificate/etc. generation and monitoring software platform, potentially in a Cloud-computer based environment (30A, 30B). In an embodiment, a blockchain may be implemented within a single Cloud-computing environment or span across two or more Cloud-computing environments. In a blockchain implementation spread across multiple Clouds, security as well as availability and stability of the entire system may be increased or improved. All transactions could be recorded by the blockchain so that the entire IoT implementation benefits from the blockchain's benefits.

Blockchain can be implemented in a manner that allows for the following attributes:

No unnecessary global sharing of data: only parties with a legitimate need to know can see the data within an agreement;

The blockchain choreographs workflow between firms without a central controller;

The blockchain achieves consensus at the level of individual deals between firms, not at the level of the system;

The design directly enables supervisory and regulatory observer nodes;

Transactions are validated by the parties to the transaction rather than a broader pool of unrelated validators;

The blockchain supports a variety of consensus mechanisms;

The blockchain records an explicit link between smart contract code and human-language legal documents;

The blockchain is built on industry-standard tools;

The blockchain may or may not have any native cryptocurrency

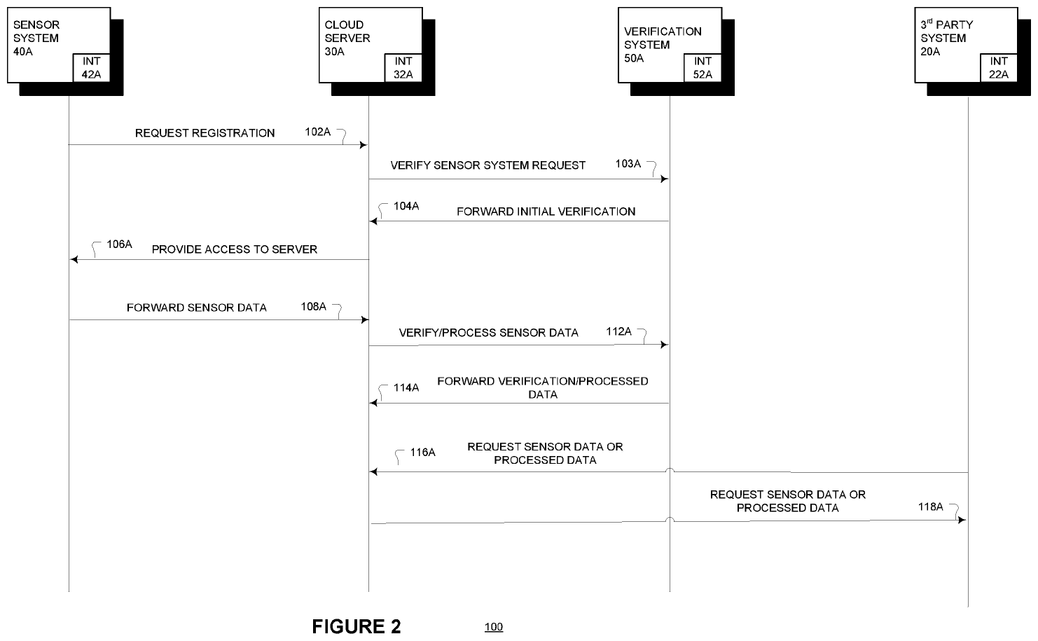

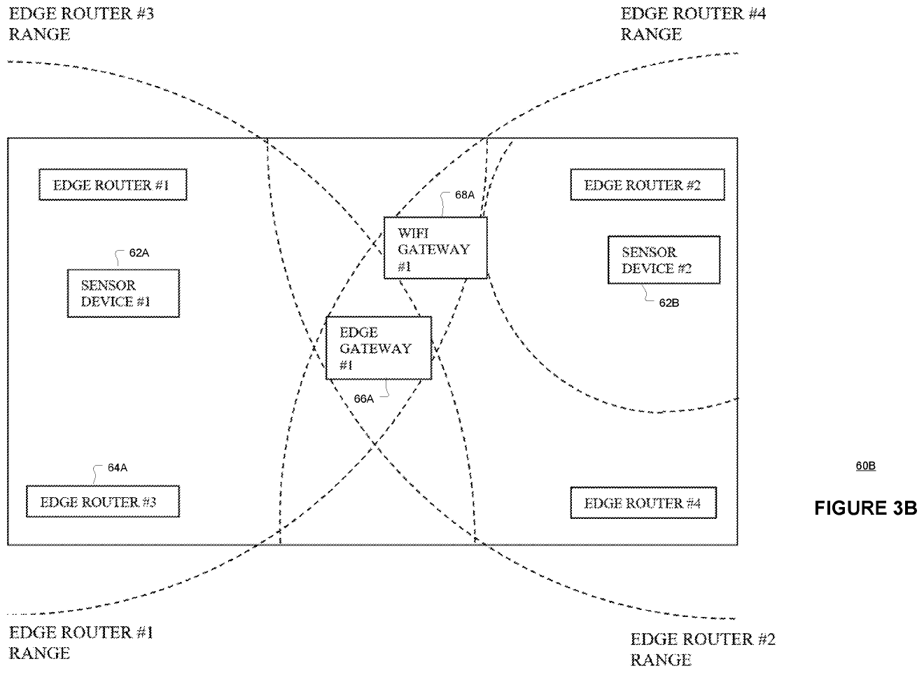

Each node on a blockchain network has a vault, and each vault has “facts”. Each fact in effect represents a SQL database record, whose access and visibility can be controlled by the node itself. So, in an IoT network, the IoT devices may need to register (communication 102A in FIG. 2) with a blockchain (hosted by cloud servers 30A-30B) for purposes of registering with the network or architecture 10 (activity 152 of algorithm 150 shown in FIG. 4. Once registered via a blockchain to contain identification and technical properties of the IoT device, then the IoT device may transmit information directly to a blockchain, potentially based on blockchain attributes, that may create an immutable record of the IoT device's transmission as well as contents of the transmission. In an embodiment, during registration, a cloud server 30A-30B may request and receive verification for a sensor system 40A (communications 103A, 104A) from a verification system 50A (activities 154 and 156). The sensor system 40A may be part of an IoT device or system. Once verified, a cloud server 30A, 30B may grant the sensor system 40A access (communication 106A and activity 158), enabling the sensor system to forward sensor data (communication 108A) that be stored by the cloud server 30A, 30B including in a block of a blockchain.

A cloud server 30A, 30B may also verify sensor data in an embodiment by forwarding the data to a verification system 50A for certification, processing, or verification and wait for verification or processed data from the verification system 50A (communications 112A, 114A and activities 164 and 168). In an embodiment, a verification system 50A may also process received sensor data 112A to generate credits, penalties, contracts, or tradeable commodities (such as carbon credits) that are forwarded a cloud server 30A, 30B for secure storage including addition to a block of a blockchain in an embodiment. Then a 3^{rd} party system may request sensor data or processed data (that represent credits, penalties, contracts, or tradeable commodities) (communication 116A) from a cloud server 30A, 30B. A cloud server 30A, 30B may forward the requested data based on agreements or certifications provided by the 3^{rd} party to be entitled to receive the data including processed data (communication 118A).

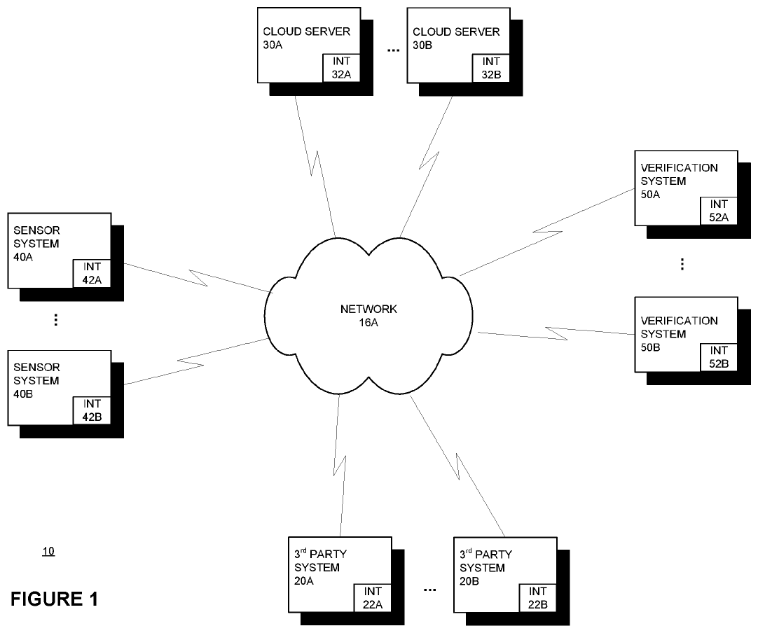

In an embodiment, certain data may be only forwarded once and noted as “used or collected” in the cloud server 30A, 30B including adding another block to a block chain to indicate its communication to a 3^{rd} party system 20A. In an embodiment, the sensor systems 40A, 40B, cloud servers 30A, 30B, verification systems 50A, 50B, and 3^{rd} party systems 20A, 20B may be part of architecture 10 shown in FIG. 1. As shown in FIG. 1, the sensor systems 40A, 40B, cloud servers 30A, 30B, verification systems 50A, 50B, and 3^{rd} party systems 20A, 20B may communication via interfaces 22A-52B across network 16A where network 16A may any communication of networks employing various communication protocols including wired and wireless protocols and platforms.

As noted, a block in a blockchain or other ledger system may provide immutable records that may be verified for use as various credits, contracts, or commodities, including carbon credits for a participating system. The carbon credit, once processed and created, may be stored in a blockchain (communications 116A, 116B). A record or block in a blockchain may potentially be the same ledger as the original records, or a separate blockchain that is only utilized for referencing a credit, contract, or commodity including a carbon credit.

In an embodiment, this distinction may be desired because the ledger collecting data may preferentially store the resulting credit, contract, or commodity. In another embodiment, the credit, contract, or commodity may be stored in an additional ledger. In an embodiment, a credit may form the basis of a smart contract can be used to effectively sell or trade the credit by a 3^{rd} party system 20A, 20B. The use of blockchain ledger to maintain smart contracts in architecture 10 may enable or form a highly secure environment or architecture 10 for managing noted incentives, penalties, costs, credits, and debits across markets and locations to promote the reduction of undesirable waste products, reduction of energy usage, more efficient energy generation, and reduction in consumption of limited resources. In an embodiment, architecture 10 may be employed for GHG programs that collect data from sensors, which may be monetized to form carbon credits.

In an embodiment, a blockchain facilitates trusted peer to peer transactions. When employed for smart contracts, the blockchains may satisfy or meet existing legal and business requirements for security and integrity without the need for an intermediary. A blockchain may be useful for business and less costly or computer intensive than crypto currencies (that may require “mining”). Accordingly, blockchain deployment may create massive efficiencies for bottom line savings while opening up new top line revenue opportunities. Further, blockchain usage or deployment in an architecture 10 may enable 3^{rd} party systems 20A, 20B to move from internal records and complex systems to transact, to global authoritative systems of record shared directly between firms. Authoritative facts may be recorded on a digital, immutable ledger, enabling settlement or trade to occur directly across the platform or architecture 10. The point to point architecture 10 may be a fundamental architectural difference from other systems.

The IoT device may potentially implement GPS to confirm during operation that it hasn't been moved or tampered with in an attempt to alter the IoT device's output to the blockchain. This GPS coordinate and/or location otherwise, along with the serial number of the device could be used in a cryptographic scheme to verify the device is accurate and verifiable during operation.

The biggest challenge for architecture 10 may (employing or not employing blockchains) may be ensuring privacy of transactions. The cloud servers 30A, 30B use of ledger with immutable records may ensure transaction privacy by sharing transactions only with parties involved in a transaction. Blockchain system's unique point-to-point architecture may employs a pluggable uniqueness consensus mechanism that can be operated as a service. The end state for blockchain networks is one where any party can transact freely and without constraint. In architecture 10, ledger assets may not be trapped within separate networks or require complex network integrations. Employment of blockchains in architecture 10 may enable a global network of nodes that may transact openly with any other node while still supporting private business networks.

In an embodiment, the basic aspect of merging carbon credits with a live trading market (via 3^{rd} party systems 20A, 20B) may be so the verification/validation process only has to be done once. In an embodiment, a smart contract of a blockchain may be tailored to model the verification from the certification of the verification process by a verification system 50A, 50B. Accordingly, the verification process may not be compromised enabling authentication of generated or verified carbon credits as accurate. In an embodiment, the incentives, penalties, costs, credits, and debits may be traded across markets and locations to promote the reduction of undesirable waste products, reduction of energy usage, more efficient energy generation, and reduction in consumption of limited resources without question as to accuracy and/or authenticity.

In an embodiment, a modified blockchain implementation maybe dedicated to carbon credit generation and monetization via IoT device sensor data. In such an embodiment, the activities may include:

An IoT device or other measurement equipment may send relevant data to the blockchain server (communication 108A from sensor system 40A to cloud server 30A and activity 162), which is immediately committed after a technical review to confirm that the data is valid and from the intended source (communications 112A, 114A from cloud server 30A to verification system 50A and activities 164, 168).

A cloud server 30A via a blockchain may implement a smart contract, simple vault, direct messaging, or some other design to contact a carbon credit verification body (verification system 50A) on a timed interval or in response to received sensor data to calculate carbon credits (or incentives, penalties, costs, credits, and debits across other desired markets).

In an embodiment, a verification body via a verification system 50A may periodically request access to sensor data stored in a cloud server 30A to calculate carbon credits (or incentives, penalties, costs, credits, and debits across other desired markets) as needed.

In an embodiment, a verification system 50A representing a verification body may be responsible for committing the data transmitted by the IoT device (sensor system 40A, 40B) in a real-time manner, on a timed interval, or otherwise (communications 108A, 112A, 114A). As noted in an embodiment, the verification body via a verification system 50A may be responsible for reviewing data sent by IoT devices under its authority, assignment, or management. Accordingly, in an embodiment, only valid data from IoT devices (registered in an embodiment) should be validated and/or verified for use in carbon credit calculations (or incentives, penalties, costs, credits, and debits across other desired markets).

In an embodiment, once the verification body calculates carbon credits/allowances/offsets/etc . . . (via verification system 40A, 40B communication 114A, activity 168). and they are register in the same or another blockchain (via a cloud sever 40A, 40B, activity 172), the carbon credits/allowances/offsets/etc. may be submitted to or requested by a carbon trading market for trade or purchase (by 3^{rd} party system 20A, 20B communications 116A, 118A).

In an embodiment, a cloud server 30A, 30B may use a blockchain implementation. In an embodiment, the blockchain implementation may be a single blockchain ledger, or multiple ledgers that are congruent to each other. Such an implementation may maintain integrity, security, authenticity, and accuracy in trading the carbon credits/allowances/offsets/etc.

In summary in an embodiment an algorithm (150 in FIG. 4) may include the following activities:

IoT devices may be registered and verified by a blockchain (cloud servers 30A, 30B and verification systems 50A, 50B, activities 152, 154, 156, 158) before allowing the devices to participate in communication with the blockchain.

Once devices (sensor systems 40A, 40B) are registered for use by a given blockchain (cloud servers 30A, 30B and verification systems 50A, 50B, activities 152, 154, 156, 158), they may begin to transmit data to the blockchain as logic on the IoT device (including registered sensor systems 40A, 40B) allows (activity 162).

In an embodiment, when a sensor system 40A, 40B sends data (communication 108A) to cloud server 30A, it is fully encrypted en route.

Once received by the blockchain (cloud server 30A, 30B), the data should be committed (stored—activity 164).

The data should be available initially only to the assigned verification body for analysis (activity 164—communication 112A).

Once the verification body (via verification system 50A, 50B) has analyzed the data, it should confirm that the data is valid and is used in calculation of carbon credits/allowances/offsets/etc (or incentives, penalties, costs, credits, and debits across markets—communication 114A).

After the verifier (via verification system 50A, 50B) calculates carbon credits (or incentives, penalties, costs, credits, and debits across other desired markets) based on a given set of data, then the carbon credits/allowances/offsets/etc. (or incentives, penalties, costs, credits, and debits across other desired markets) may be submitted to or requested by a market (via a 3^{rd} party system) for purchase or trade, either in real time, on a scheduled interval, or on scheduled times.

It is noted that There are many versions of a “blockchain” implementation. This disclosure describes a few potential versions. Blockchains are described as a sequence of blocks consisting of a transaction that is joined with a block of data. The transaction and associated data represent a block of information. The block is potentially run through an encryption algorithm known as a hash function, and the result is stored in the previous block as a reference to the block that follows. In this manner, each block has an encrypted reference as to the location of the next block in the chain. Hence, a block chain. However, that is an implementation that can be run on a single standalone computing device.

In a cloud environment, one could implement data storage of a “block” as described above involving a transaction and a set of data in another manner. Take for instance RAID storage, whereby data is written across multiple hard drives on a single computer. If you think of writing a block or just the data itself across multiple servers as if each server was another drive in a RAID storage mechanism, then you can record blocks or individual data records across a cluster of data storage servers as if each server was a physical drive in a RAID array. Where it gets interesting from a security standpoint is if you treat a cluster of servers in a manner consistent with RAID 5, 6, or higher involving striping, mirroring, and/or parity to record data. But with an extra security layer. What if a segment of the data and/or transaction in a block was encrypted and then written to a different server with a hash of the location/network address of the corresponding block parts to other servers? This could be done in a manner consistent with any RAID storage mechanism such as striping, mirroring, and/or parity except each server or servers in a cluster are treated as physical drives in a RAID array. This would have the effect of having a software abstraction layer that understands a specific encryption scheme across the entire cluster where the blocks are stored. However, this scheme would not allow anyone who has access to the storage space only on each server be able to recover any data without decrypting all the servers in the cluster and then piecing the files back together. The software used to write blocks across the server cluster would be the only means by which data can be easily recovered. This scheme would provide significant additional security to any storage facility well beyond what is currently available in a single database server or single database server clustered environment.

So, in considering the previous example, apply RAID 5 or 6 to a cluster of servers. If you write part of one block to one server, and another part to another server, and another part to another server, and then another part to a fourth server, with parity to all other servers, then one server can crash and the data can still be recovered. However, if using the encryption scheme above for each segment of the file (or potentially a block as described), then a server in the cluster can crash or be otherwise unavailable and the data/block is still safe from hackers or unwanted access, but potentially still recoverable and accessible by the software managing the storage scheme.

As discussed previously, measurements for carbon-based allowances or offsets can be calculated and stored in a blockchain based architecture. In the case that the carbon-based measurements (renewable, efficiency, water, etc.) are stored in a blockchain, then that same or an additional blockchain implementation can provide what is referred to as a “cryptocurrency” based on the carbon values provided in an embodiment. In this embodiment, a “cryptocurrency” may be “backed by” carbon-based certificates, credits, or any other form of carbon instrument (or incentives, penalties, costs, credits, and debits across other desired markets).

In such an embodiment, the usage of a cryptocurrency that may be instituted by carbon savings (or incentives, penalties, costs, credits, and debits across other desired markets) and may support reinvestment of associated profits, residuals, or other means of monetization into additional mechanisms that encourage or accelerate adoption of environmentally efficient practices. Any market that subscribes to this business model must require some of the profits to be directly and/or indirectly invested into projects that could potentially deliver renewable energy or energy efficiencies into actual use, or may introduce energy efficient methods into commercialization in the future.

In a further embodiment a blockchain may allow for valuations such as “Bitcoin” to be generated by computing processes involving algorithms, but the same platform/market may also allow for creation of valuations that may represent valuations on the same market that may be created by entities producing renewable energy and/or energy efficiencies in the energy market. The merging of existing carbon instruments (or incentives, penalties, costs, credits, and debits across other desired markets) with cryptocurrency instruments may create an entirely new financial market that allows for digital currency and energy efficiency to benefit from, assimilate to, and profit with each other moving forward.

In an embodiment for every cryptocurrency unit that is processed, or “mined”, on this carbon-associated market (or incentives, penalties, costs, credits, and debits across other desired markets), a percentage of the currency may be dedicated to achieving carbon efficiencies (or incentives, penalties, costs, credits, and debits across other desired markets). This embodiment could be augmented by participating entities that reduce carbon usage or produce renewable energy by allowing their activities to also produce cryptocurrency units in an equivalent monetary value, or in a scale that is deemed fair in relation to the cryptocurrency markets. Other models may include purchasing cryptocurrency but specifying a percentage of the purchase go towards energy efficiency efforts (or incentives, penalties, costs, credits, and debits across other desired markets). Another embodiment could have an agreed to purchase or ongoing valuation of the cryptocurrency unit automatically being utilized at a time specified by the instrument, market, seller or buyer to be utilized in carbon reduction. In doing so, this embodiment may elevate both the cryptocurrency market and the carbon and other desired markets in potential value, ownership, and interest.

In another embodiment the producer of the renewable energy/carbon allowance, credit or certificate (or incentives, penalties, costs, credits, and debits across other desired markets) to allow a partial value of that effort to go towards “backing” or endorsing a cryptocurrency unit. Such an embodiment may allow for the carbon or other desired market to benefit in the cryptocurrency market. In particular, when a cryptocurrency unit is created, it may be directly and/or indirectly attached to a carbon reduction benefit (or incentives, penalties, costs, credits, and debits across other desired markets). Alternately, when a carbon offset/allowance/credit (or incentives, penalties, costs, credits, and debits across other desired markets) is generated by the energy (or other source) provider/consumer, that instrument may automatically be converted to a cryptocurrency unit in part or in full to realize monetization.

The monetization of carbon allowances/offsets/credits/certificates and incentives, penalties, costs, credits, and debits across other desired markets has been historically an obscure process involving registries alongside desired markets that have implemented a variety of trading barriers. By monetizing carbon and other benefits in this manner and attaching them to cryptocurrencies in any of the above-mentioned strategies or otherwise, the move to reduce carbon emissions, other undesired activity, and desired activities may be dramatically accelerated.

In an embodiment, a carbon “registry” may be formed, whereby Greenhouse Gas (GHG) Emissions Programs are registered per ISO 14064 and ISO 14065 standards. These “registries” can also be integrated into the aforementioned architecture 10. Although they can also be maintained outside the architecture 10, it may be recommended that any future carbon registry be implemented on via architecture 10 to increase security, reduce volatility and fraud, as well as maintain a consistent data storage mechanism. If a carbon registry were to implement its storage as recited in architecture 10, it may ensure no replication of carbon certificates/allowances/credits are issued, as well as ensure no fraudulent records are produced.

There may be carbon registries that allow entities to register GHG emissions programs, and if approved, from approval date on the registries allow the entities that own or manage the GHG emissions program to receive carbon certifications/allowances/offsets/credits/etc. based on future efficiencies/renewable power production. In such a configuration there may be no guarantees that the future carbon certifications/allowances/offsets/credits/etc. are valid as participants may submit billing statements/monthly reports/etc. to verify power usage.

Such a configuration may not be exact or precise in any way and may create fraudulent practices. In an embodiment, after a GHG emissions program is approved, a form of electronic wattage or water usage meter that can automatically transmit data on a standardized interval up to an Internet enabled network, preferably a Cloud-based data storage facility is employed. To improve the accuracy and security of the data being transmitted, the sensor data should be encrypted from the measurement/sensor system 40A, 40B all the way to the data storage facility (cloud server 30A, 30B). To further improve the integrity of architecture 10, the data storage facility (cloud server 30A, 30B) may be based on a blockchain implementation as that would implement an “immutable” data storage implementation on the Cloud. Regardless of what storage implementation is used, the “registry” as well as the data storage implementation (cloud server 30A, 30B) used to back up the metering devices (sensor systems 40A, 40B) should be an “immutable” data storage facility in an embodiment. All aspects of the aforementioned architecture 10 as well as the implementations described in the U.S. Provisional Application No. 62/610,479, filed Dec. 26, 2017, which is incorporated by reference may incorporate data storage facilities that support full data encryption as well as insertion of data that cannot be altered once submitted in an embodiment.

The cryptocurrency model described herein may potentially allow entities that produce renewable energy or energy efficiencies to be issued corresponding cryptocurrency units instead of carbon certificates/allowances/offsets/etc. on a carbon or other desired market, or issued carbon or other desired instruments that can be converted into cryptocurrency. In another embodiment, the carbon or other desired markets may adopt a more fluid environment much like the cryptocurrency markets have enabled. By linking carbon or other desired merit and cryptocurrency, the concept allows digital currency to be ensured by carbon or other desired merit offsets.

Such an embodiment employs a digital currency that has no limited-availability commodity associated with it. For instance, most first-world currencies are “backed” by gold, hence the “gold standard”. Such currencies have some physical assurance that it has determined value. Although such standard may have not been fully maintained, the concept still applies. However, digital currency is not backed by a limited resource. Accordingly employing a digital currency to be endorsed, or “backed” by carbon allowances/certificates/credits/etc may not be limited as traditional currencies. A digital currency is associated with carbon reduction, may potentially accelerate the reduction of fossil fuels, for example, creating perhaps a “carbon standard”.

In another embodiment each cryptocurrency unit that is generated through “data mining” or computer processing may be done so with the understanding that a certain percentage of it's worth may be applied towards reducing carbon emissions or some undesired activity, or increasing a desirable activity in some capacity. Such an embodiment could serve to promote renewable energy production or energy efficiency efforts. The simplification of carbon allowances/certificates/offsets/etc. would be benefitted if they were normalized on both the renewable energy production side as well as the energy efficiency consumption side for example. If normalized, both the production and consumption side could be represented as a single commodity, or carbon instrument for example.

In addition to the above embodiments, carbon or other desired merit instruments may be then be converted into a unit of cryptocurrency and stored in a blockchain or other secure, immutable implementation of any of the variations mentioned in this disclosure. The same blockchain or other secure, immutable implementation may also support “data mining” for cryptocurrency creation similar how to “Bitcoin” works. By supporting creation of cryptocurrency units in a single cryptocurrency market via energy efficiencies and/or renewable or “greener” energy production as well as data mining, this market may allow individuals as well as companies such as utilities to participate in a cryptocurrency market that is designed to promote carbon efficiencies and/or renewable or more environmentally safe energy sources, for example.

Some of the proceeds from the sale and/or trade of this type of cryptocurrency could be used to build and maintain renewable energy production facilities like solar and wind farms, or be used to implement energy efficiency programs on buildings in say, for instance, economically challenged geographic areas. This could in turn facilitate additional carbon offset/certificate/allowance production that could be used to generate additional cryptocurrency units for years to come.

In another embodiment, a cryptocurrency market may support at any time the cryptocurrency units being converted back into carbon offsets/certificates/allowances/etc. or other desired merit for use by an entity in achieving carbon reduction goals or to hold as a carbon-based instrument that can later be reconverted back into a cryptocurrency unit, for example. These cryptocurrency units could be referred to as carbon coins, carbon currency, or some similar suitable name that references the association with carbon reduction programs or other desired merit related to other desired activities as described above.

The above carbon-based cryptocurrency market schemes may or may not incorporate any of the aspects mentioned in U.S. Provisional Application No. 62/610,479, filed Dec. 26, 2017, which is incorporated by reference. An embodiment may also include any provisions laid out in ISO standards 14064 parts 1-3, 14065, or 14066.

In an embodiment, creating and managing a cryptocurrency market, may in effect eliminate the need for existing carbon or other desired merit markets as they are based on government enforcement of carbon reduction incentivization schemes like cap-and-trade policies as well as similar mechanisms to ensure/promote enforcement by participating companies and/or utilities. The new embodiments disclosed herein may create incentivization to participate in carbon reduction and clean energy production for the purposes of creating cryptocurrency units that can be immediately and/or actively traded for cash on a cryptocurrency market, for example.

Similarly, in an embodiment, people/entities wanting to data mine cryptocurrency may also participate in the same or another dedicated cryptocurrency market that may include set-asides and direct investment strategies identified in this disclosure to create new clean energy sources and energy efficiency implementations. These investment strategies may include investment in other inventions that promote clean energy production or energy efficiencies and/or direct construction of new clean energy sources. These investment strategies may include a percentage of the creation and/or trading of the cryptocurrency units themselves from the carbon validation/verification side as well as from the data mining side of the market. In an embodiment there may be two separate cryptocurrency markets, one dedicated to carbon offsetting/reduction efforts while another is dedicated to data mining similar to what “Bitcoin” is performing today.

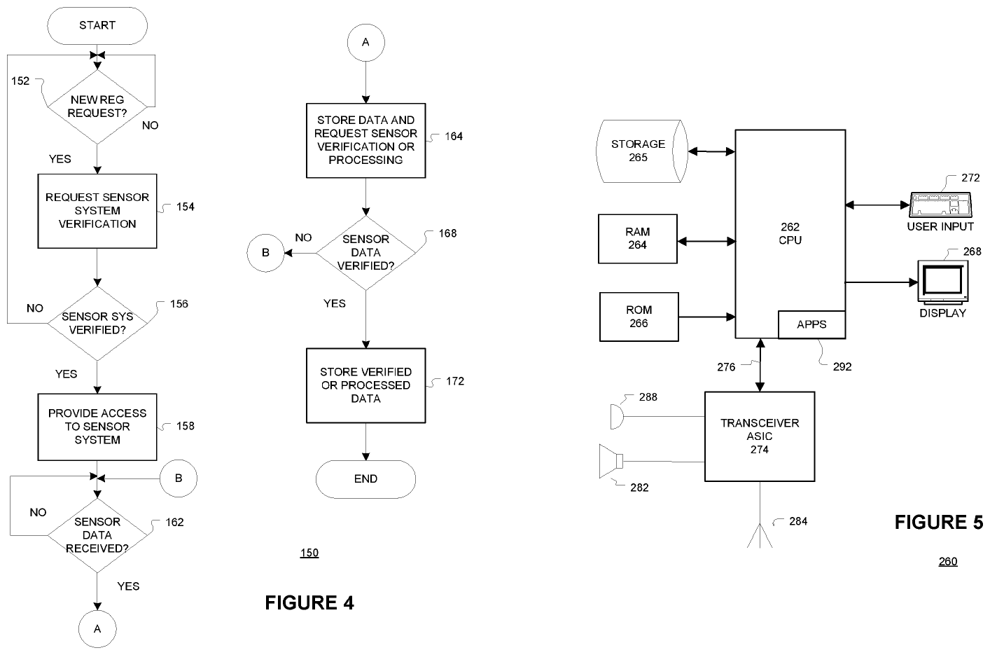

A device 260 is shown in FIG. 5 that may be used in various embodiments as a 3^{rd} party system 20A, a verification system 50A, a sensor system 40A, and a cloud server 30A. The device 260 may include a central processing unit (CPU) 262, a random-access memory (RAM) 264, a read only memory (ROM″) 266, a display 268, an input device 272, a transceiver application specific integrated circuit (ASIC) 274, a microphone 288, a speaker 282, a storage unit 265, and an antenna 284. The CPU 262 may include an application module 292 including a browser application module. The RAM 264 may store verification, sensor, processed, and 3^{rd} party data.

In an embodiment, the applications 292 may be a separate module. The application module 292 may be used to encrypt sensor data, verify sensors and sensor data, process sensor data, form immutable ledger data, and other activities of architecture 10. The storage device 265 may comprise any convenient form of data storage and may be used to store temporary program information, queues, databases, sensor data, processed data, and overhead information.

The ROM 266 may be coupled to the CPU 262 and may store the program instructions to be executed by the CPU 262, and the application module 292. The RAM 264 may be coupled to the CPU 262 and may store temporary program data, sensor data, and overhead information. The user input device 272 may comprise an input device such as a keypad, touch screen, track ball or other similar input device that enables a user to navigate through menus, displays in order to operate the device 260. The display 268 may be an output device such as a CRT, LCD, touch screen, or other similar screen display that enables the user to read, view, or hear received messages, displays, or pages.

A microphone 288 and a speaker 282 may be incorporated into the device 260. The microphone 288 and speaker 282 may also be separated from the device 260. Received data may be transmitted to the CPU 262 via a bus 276 where the data may include messages, displays, or pages received, messages, displays, or pages to be transmitted, or protocol information. The transceiver ASIC 274 may include an instruction set necessary to communicate messages, displays, or pages in architecture 10. The ASIC 274 may be coupled to the antenna 284 to communicate wireless messages, displays, or pages within the architecture 10. When a message is received by the transceiver ASIC 274, its corresponding data may be transferred to the CPU 262 via the bus 276. The data can include wireless protocol, overhead information, and pages and displays to be processed by the device 260 in accordance with the methods described herein.

Any of the components previously described can be implemented in a number of ways, including embodiments in software. Any of the components previously described can be implemented in a number of ways, including embodiments in software. Thus, the CPU 232, web-server 254, application module 252, modem/transceiver 244, antenna 246, storage 238, RAM 234, ROM 236, database 248, database 256, CPU 262, application module 292, transceiver ASIC 274, antenna 284, microphone 288, speaker 282, ROM 266, RAM 264, user input 272, display 268, verification system 50A, sensor system 40A, cloud server 30A, and 3^{rd} party system 20A, may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, may be apparent to those of skill in the art upon reviewing the above description.

The Abstract of the Disclosure is provided to comply with 37 C.F.R. § 1.72(b), requiring an abstract that may allow the reader to quickly ascertain the nature of the technical disclosure. It is submitted with the understanding that it may not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

1. A method of promoting the reduction of undesirable waste products, the reduction of energy usage, more efficient energy generation, and the reduction in consumption of limited resources, including:
monitoring data from a physical data sensor where the data indicates the level of one of reduction of undesirable waste product generation, reduction of energy usage, more efficient energy generation, and reduction in consumption of limited resources; and
receiving and verifying the monitored data and creating one of incentives, penalties, costs, credits, tradable commodities, and debits based on the received and verified monitored data.

2. The method of promoting the reduction of undesirable waste products, the reduction of energy usage, more efficient energy generation, and the reduction in consumption of limited resources of claim 1, wherein the monitoring of data from a physical data sensor includes storing the received data and verified data in an immutable record of a server.

3. The method of promoting the reduction of undesirable waste products, the reduction of energy usage, more efficient energy generation, and the reduction in consumption of limited resources of claim 1, wherein the monitoring of data from a physical data sensor includes storing the received data and verified data in a block of a blockchain of a server.

4. The method of promoting the reduction of undesirable waste products, the reduction of energy usage, more efficient energy generation, and the reduction in consumption of limited resources of claim 3, wherein an Internet of Things device incorporates the physical data sensor for monitoring data.

5. The method of promoting the reduction of undesirable waste products, the reduction of energy usage, more efficient energy generation, and the reduction in consumption of limited resources of claim 4, wherein the server is a cloud server.

6. The method of promoting the reduction of undesirable waste products, the reduction of energy usage, more efficient energy generation, and the reduction in consumption of limited resources of claim 5, wherein the Internet of Things device that incorporates the physical data sensor for monitoring data is verified by a 3^{rd} party server.

7. The method of promoting the reduction of undesirable waste products, the reduction of energy usage, more efficient energy generation, and the reduction in consumption of limited resources of claim 6, wherein tradable commodities are created based on the received and verified monitored data.

8. The method of promoting the reduction of undesirable waste products, the reduction of energy usage, more efficient energy generation, and the reduction in consumption of limited resources of claim 6, wherein tradable commodities are created based on the received and verified monitored data and stored in a block of a blockchain.

9. The method of promoting the reduction of undesirable waste products, the reduction of energy usage, more efficient energy generation, and the reduction in consumption of limited resources of claim 8, wherein the tradable commodities are tradable via a 3^{rd} party server.

10. The method of promoting the reduction of undesirable waste products, the reduction of energy usage, more efficient energy generation, and the reduction in consumption of limited resources of claim 9, wherein the tradable commodities represents carbon credits.

11. The method of promoting the reduction of undesirable waste products, the reduction of energy usage, more efficient energy generation, and the reduction in consumption of limited resources of claim 9, wherein the tradable commodities are smart contracts tradable via a 3^{rd} party server.

12. The method of promoting the reduction of undesirable waste products, the reduction of energy usage, more efficient energy generation, and the reduction in consumption of limited resources of claim 4, wherein the received data from the physical data sensor at the server is encrypted.

13. The method of promoting the reduction of undesirable waste products, the reduction of energy usage, more efficient energy generation, and the reduction in consumption of limited resources of claim 4, wherein the server verifies the accuracy of the sensor data and creates one of incentives, penalties, costs, credits, and debits as a function of the verified sensor data.

14. The method of promoting the reduction of undesirable waste products, the reduction of energy usage, more efficient energy generation, and the reduction in consumption of limited resources of claim 13, wherein the monitored data from the physical data sensor indicates the level of reduction of undesirable waste product generation.

15. The method of promoting the reduction of undesirable waste products, the reduction of energy usage, more efficient energy generation, and the reduction in consumption of limited resources of claim 14, wherein the undesirable waste product consists of greenhouse gases.

16. The method of promoting the reduction of undesirable waste products, the reduction of energy usage, more efficient energy generation, and the reduction in consumption of limited resources of claim 15, wherein the server creates greenhouse gas credits.

17. A system for promoting the reduction of undesirable waste products, the reduction of energy usage, more efficient energy generation, and the reduction in consumption of limited resources, the system including:
a physical data sensor for monitoring data that indicates the level of one of reduction of undesirable waste product generation, reduction of energy usage, more efficient energy generation, and reduction in consumption of limited resources; and
a server for receiving and verifying the monitored data and creating one of incentives, penalties, costs, credits, tradable commodities, and debits based on the received and verified monitored data.

18. The system for promoting the reduction of undesirable waste products, the reduction of energy usage, more efficient energy generation, and the reduction in consumption of limited resources of claim 17, wherein the server stores the received data and verified data in an immutable record.

19. The system for promoting the reduction of undesirable waste products, the reduction of energy usage, more efficient energy generation, and the reduction in consumption of limited resources of claim 17, wherein the server stores the received data and verified data in a block of a blockchain.

20. The system for promoting the reduction of undesirable waste products, the reduction of energy usage, more efficient energy generation, and the reduction in consumption of limited resources of claim 19, wherein the system includes an Internet of Things device that incorporates the physical data sensor for monitoring data.

21. The system for promoting the reduction of undesirable waste products, the reduction of energy usage, more efficient energy generation, and the reduction in consumption of limited resources of claim 20, wherein the server is a cloud server.

22. The system for promoting the reduction of undesirable waste products, the reduction of energy usage, more efficient energy generation, and the reduction in consumption of limited resources of claim 20, wherein the Internet of Things device encrypts the physical data sensor monitored data.

23. The system for promoting the reduction of undesirable waste products, the reduction of energy usage, more efficient energy generation, and the reduction in consumption of limited resources of claim 20, further including a verification server that independently verifies monitored data from a physical data sensor and the server forwards received monitored data to the verification server for independent verification.

24. The system for promoting the reduction of undesirable waste products, the reduction of energy usage, more efficient energy generation, and the reduction in consumption of limited resources of claim 23, wherein the monitored data from the physical data sensor indicates the level of reduction of undesirable waste product generation.

25. The system for promoting the reduction of undesirable waste products, the reduction of energy usage, more efficient energy generation, and the reduction in consumption of limited resources of claim 24, wherein the undesirable waste product consists of greenhouse gases.

26. The system for promoting the reduction of undesirable waste products, the reduction of energy usage, more efficient energy generation, and the reduction in consumption of limited resources of claim 25, wherein the server creates greenhouse gas credits.

27. The system for promoting the reduction of undesirable waste products, the reduction of energy usage, more efficient energy generation, and the reduction in consumption of limited resources of claim 20, further including a 3^{rd} party sensor that independently verifies the Internet of Things device that incorporates the physical data sensor for monitoring data.

28. The system for promoting the reduction of undesirable waste products, the reduction of energy usage, more efficient energy generation, and the reduction in consumption of limited resources of claim 27, wherein the server creates tradable commodities based on the received and verified monitored data.

29. The system for promoting the reduction of undesirable waste products, the reduction of energy usage, more efficient energy generation, and the reduction in consumption of limited resources of claim 27, wherein the server creates tradable commodities based on the received and verified monitored data and stores the created tradable commodities in blocks of a blockchain.

30. The system for promoting the reduction of undesirable waste products, the reduction of energy usage, more efficient energy generation, and the reduction in consumption of limited resources of claim 27, further including a 3^{rd} party server for trading the tradable commodities.

31. The system for promoting the reduction of undesirable waste products, the reduction of energy usage, more efficient energy generation, and the reduction in consumption of limited resources of claim 30, wherein the tradable commodities represents carbon credits.

32. The system for promoting the reduction of undesirable waste products, the reduction of energy usage, more efficient energy generation, and the reduction in consumption of limited resources of claim 27, wherein the tradable commodities are smart contracts and further including a 3^{rd} party server for trading the smart contracts.
